(19) United States
(12) Patent Application Publication
(10) Pub. No.: US 2008/0079677 A1
(43) Pub. Date: Apr. 3, 2008

(54) METHOD FOR DRIVING DISPLAY

(75) Inventors: Wen-Chih Tai, Taoyuan County (TW); Kuang-Lang Chen, Taoyuan County (TW); Chi-Neng Mo, Taoyuan Hsien (TW); Chia-Lin Liu, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CHUNGHWA PICTURE TUBES, LTD., Taipei (TW)

(21) Appl. No.: 11/739,109

(22) Filed: Apr. 24, 2007

(30) Foreign Application Priority Data
Sep. 29, 2006 (TW) 95136195

(51) Int. Cl. G09G 3/36

(52) U.S. Cl. 345/88

(57) ABSTRACT

A method for driving a display device includes the following steps: providing a first displaying data to a first region of a display panel, wherein the first displaying data is a first color displaying data; providing a backlight source of the first color at the first region; and displaying a black color at a specific region neighboring to the first region. Accordingly two different colors will not neighbor with each other based on the above-mentioned method and thus the color deviation problem caused by different color backlight sources is solved by this invention.

### CROSS-REFERENCE TO RELATED APPLICATION

This application claims the priority benefit of Taiwan application serial no. 95136195, filed Sep. 29, 2006. All disclosure of the Taiwan application is incorporated herein by reference.

### BACKGROUND OF THE INVENTION

1. Field of the Invention

The present invention relates to a driving method for displays, and more particularly, relates to a driving method employed color sequence method to lighten up the backlight sources by sections for displays.

2. Description of Related Art

In recent years, with great advance in the fabricating techniques of electrical-optical and semiconductor devices, flat panel displays (FPDs), such as liquid crystal displays (LCDs), have been developed. Due to the advantageous features of LCD, for example, high space utilization efficiency, low power consumption, free radiation, and low electrical field interference, so that LCD has become main stream on the market. A LCD mainly comprises a liquid crystal display (LCD) panel and a backlight module. The LCD panel does not emit light itself so that the backlight module is arranged below the LCD panel to provide the surface light source for the LCD panel so as to perform the display function.

In a conventional LCD, the light sources of the backlight module provides a white light, and the LCD displays different colors through the color filter disposed on each pixel region. In general, there are three color filters, red (represented by R), green (represented by G), and blue (represented by B) disposed on each pixel region, which not only cost more but also have poor light transmittance through the color filters and the color deviation problem caused by neighboring colors. However, if a black matrix is implemented to separate the color filters, it maybe decreases the color deviation problem but also brings down the light transmittance ratio of the color filters even more.

Besides, as shown in FIG. 3, the design mentioned above of the LCD panels utilizing color filters; it transports data sequentially to the source drivers 302 to 306 by a source connector 301 using the shift ready method according to a synchronization signal (STH) and thus causes that the backlight sources cannot be lightened up due to the shortage of time and the long scanning time of the panels.

While in the advanced design of LCD, a light-emitting diodes (LED) backlight source is generally utilized to replace the traditional backlight source to display the colors of the pixels. In other words, the color mixing on the axis of space, for example, the three sub-pixels of red, green and blue colors mixed together, is replaced by utilizing the LED as backlight source and mixing the three sub-pixels colors on the axis of time (rapidly switching the red, green, and blue colors of the LED backlight source within a range of time of visual persistence with the human being. Base on the following description of the LED backlight source, it could be improved the light transmittance ratio and unrequired the color filters.

However, if the displaying of dynamic images is at 60 frames per second, it will take at least 180 images per second as to rapidly switching the red, green and blue colors images on the axis of time. Moreover, considering the responding time of the LCD, i.e. the time to transport the displaying data to the LCD panel, because of the backlight sources of the pixels will be lightened after the responding time of the LCD; it shortens the time for lightening the backlight and thus causes decreasing of the displaying brightness and a higher instantaneous power to the LED.

However, when utilizing the backlight sources of red, green and blue colors image switching rapidly to keep the backlight sources lightened up by time division multiple lightening, it will often cause the problem of color breakup. In order to solve the problem of color breakup, the refresh frequency of the display panel gets higher and the responding time of LCD become even less. However, the shortest responding time of the present LCD is limited and can not match the frequency of the time division multiple lightened up three colors pictures.

To improve the problems mentioned above, the backlight sources within the LCD are lightened up utilizing the method of scanning backlight by regions. FIG. 1 is a schematic view showing the backlight sources of three colors red, green and blue are lightened up by scanning backlight method regionally. Referring to FIG. 1, suppose the frame of the LCD is divided into three regions, and the following explanation is according to the displaying data of red, green and blue of the standardized color sequence method. During the N^{th} time period, a first region S110 is refreshed with new red color displaying data, wherein a second region S120 and a third region S130 are displayed the blue color displaying data which are refreshed before the N^{th} time period. During the (N+1)^{th} time period, the second region S120 is refreshed with new red color displaying data, wherein the third region S130 is displayed the blue color displaying data which are refreshed before the (N+1)^{th} time period. And during the (N+2)^{th} time period, the third region S130 is refreshed with new red color displaying data, wherein the first region S110 is also refreshed with new green color displaying data; and, likewise to complete the refreshing of green and blue color displaying data.

Although, it prolongs the time for the backlight sources to react considering the responding time of the LCD, the color deviation problem often occurs since two different backlight sources are lightened up at neighboring regions of the LCD. Usually, an isolating board is disposed on the backlight module to separate the backlight sources of different regions in the scanning backlight method, but the size of the isolating board is overlapped with the position of the pixels of the LCD panel. Therefore, another design in the prior is to dispose the light-emitting diodes (LED) around the LCD panel and using a light guiding stick to channel the light sources into different regions to be lightened up by time division multiple lightening. It maybe improves the above mentioned color deviation problem a little, however the problem of neighboring backlights interfere with each other still exist.

### SUMMARY OF THE INVENTION

The present invention is to provide a driving method for a display device utilizing a scanning backlight method, wherein the backlight source of the display panel is lightened up according to a color sequence method by regions. And to achieve the purpose of displaying colors and avoid the color deviation problem of different light sources within the limited responding time of the display devices.

The present invention provides a method for driving a display device adapted for driving a display panel. The method includes the steps of: dividing the display panel into a plurality of regions; providing a first displaying data to a first region of the display panel, wherein the first displaying data is the first color data; providing the backlight of the first color at the first region; and displaying black color at a specific region neighboring the first region.

According to an embodiment of the method for driving a display device of the present invention, the above mentioned method of displaying the black color at the specific region includes: enabling a pixel discharge function of a scan driver, when the display panel is of normally black LCD panel, wherein the scan driver is used for performing the scan function in the specific region; if the display panel is normally white LCD panel, inputting a black frame data voltage to all the pixels on a scan lines of the specific region when the scan driver is drived the scan lines of the specific region. In the other embodiment, when the color displayed at the specific region is different from the first color, the backlight of the specific region is turned off.

According to a preferred embodiment of the method for driving a display device of the present invention, the above mentioned design of a driving circuit is to add on a control pins which is controlled all of the data pins of a source driver to the source driver of the display panel, wherein the black image data is outputted from the data pins of the source driver when the control pin is enabled. It can further add on pins to a gate driver to control all of the gate pins of a gate driver to turn on or off simultaneously to block the backlight source of the specific region by displaying black color at the same time, wherein the gate driver controls the specific region of the display panel and operates in accordance with the black image data outputted from the data pins of the source driver. In the other embodiment, it can simply accomplish the displaying of black color to the specific region by utilizing the black image data transmitted to the source driver to display the black image without adding control pins of to the gate driver or source driver.

The present invention adopts a color sequence method, which utilizes the method of scanning backlight to lighten up backlight by regions to archive displaying black color data at specific region, the invention not only can achieve the objective of displaying all color pictures within limited responding time of the display but also can solve the color deviation problem caused by two different backlights lightened up at neighboring regions and prolong the time for the backlight.

In order to the make the aforementioned and other objects, features and advantages of the present invention comprehensible, a preferred embodiment accompanied with figures are described in detail below.

### BRIEF DESCRIPTION OF THE DRAWINGS

FIG. 1 is a drawing schematically illustrating a conventional technique of utilizing the method of scanning backlight to lighten up the RGB backlight sources by region.

FIG. 2A is a schematic diagram showing a displaying process of the three regions of the LCD panel according to one embodiment of the present invention.

FIG. 2B is a timing diagram showing a displaying process of the three regions of the LCD panel.

FIG. 3 showing a conventional design of the LCD panel utilizing color filters.

FIG. 4 shows a diagram of the design of LCD panels according to one embodiment of the present invention.

FIG. 5 is a schematic diagram showing a displaying process of lightening the backlight sources of the complete LCD panel divided into five regions.

FIG. 6 shows a diagram of the design of LCD panels according to another embodiment of the present invention.

FIG. 7 schematically shows a flow chart illustrating a method for updating displaying data according to an embodiment of the present invention.

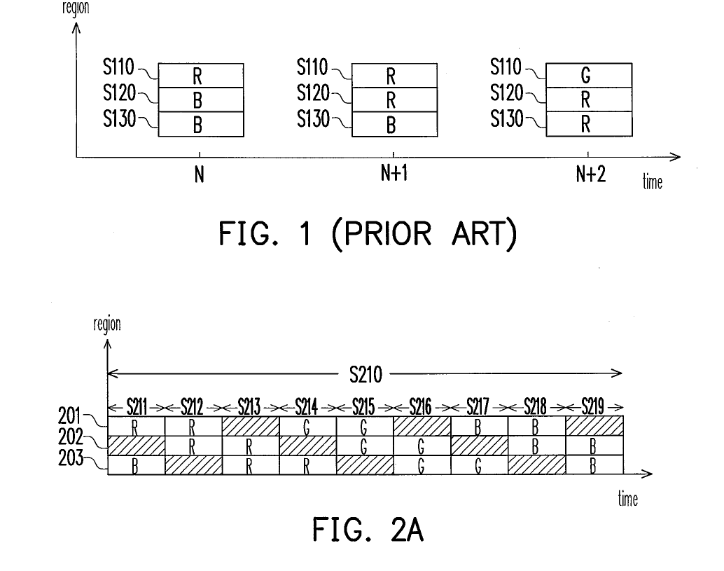

### DESCRIPTION OF EMBODIMENTS

Before further describing the essence of the present invention by embodiments, first, assuming that the display device applied in below embodiments of the present invention is a transmissive LCD device, which displays dynamic images at 60 frames per second. In addition, assuming that the above mentioned LCD device utilizes the LEDs as the backlight source, wherein the lights provided by the backlight source are, for example, red (R), green (G) and blue (B) color. Based on the above assumption, it takes 1/60 (16.67) microseconds to complete the process of transmitting data to the LCD panel and lightening up the RGB backlight sequentially to display a frame normally. As mentioned above in the assumption, the time for displaying a frame is a synchronous time period.

However, it will be apparent to those skilled in the art that the synchronous time period will change in accordance with the refresh frequency of the display panel. Besides, other type of backlight sources can be used based on the modern technology except the above mentioned LEDs, for example, plasma planar backlight source, cold cathode fluorescent lamps of different colors, or other sources that may be available in the future based on other techniques which we do not know yet, so that the present invention should not be limited to the above mentioned.

Moreover, the backlight colors of red, green and blue as mentioned above as the backlight colors are simply an example of colors that are often seen in the conventional techniques. There is a forth color, white color backlight besides the RGB colors in current techniques too, i.e. RGBW four color backlight sources. And we do not know yet if there will be technique utilizing other backlight colors developed in the future, thus the color of the backlight sources should not be limited to red, green and blue.

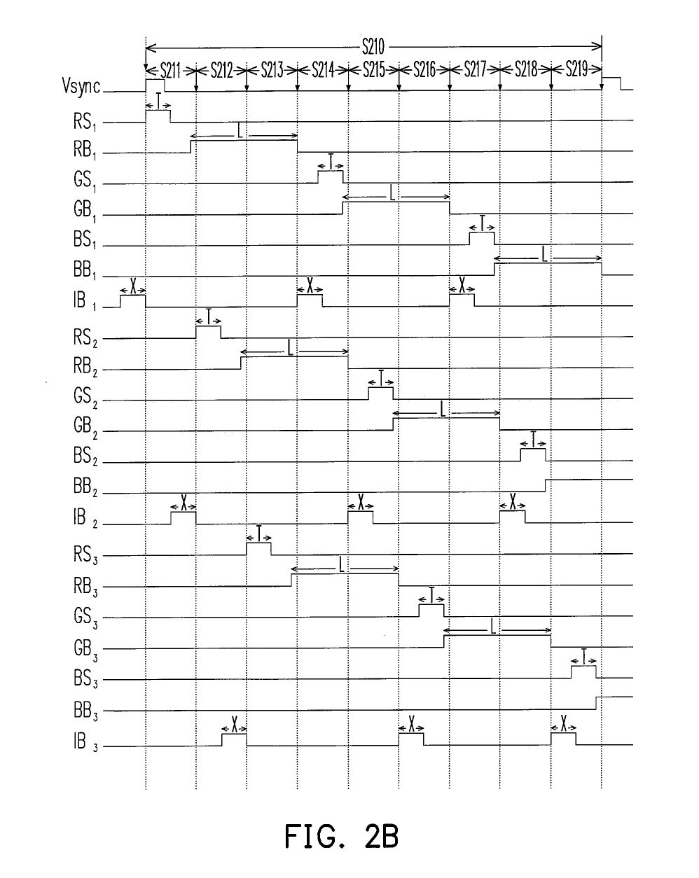

FIG. 2A is a schematic diagram showing the displaying process of the three regions of the LCD panel according to a preferred embodiment of the present invention. Referring to the FIG. 2A, a first region 201 includes a first scan line of the LCD panel. The first region 201 is neighbored to a second region 202. The second region 202 is neighbored to a third region 203 and the synchronous time period S210 includes nine periods S211 to S219 in the diagram. One of the three regions 201˜203 of the LCD panel is refreshed by one kind of color display data during each period S211˜S219, and a specific region neighbored to the above-mentioned region displays the black color to avoid the color deviation problem. The following description is performed in accordance with the FIG. 2A.

Suppose according to the standard color sequence method, the display sequence is red, green and blue sequentially. The first region 201 is refreshed and displayed according to the red color displaying data during the first period S211. The second region 202 neighbored to the first region 202 is displayed the black color, and the third region 203 is displayed the blue color according to the data of the previous frame during the first period S211.

Then, during the second period S212, the second region 202 is refreshed and displayed according to the red color displaying data, the third region 203 neighbored to the second region 202 is displayed the black color and the first region 201 is displayed the red color according to the red color displaying data refreshed during the first period S211.

During the third period S213, the third region 203 is refreshed and displayed according to the red color displaying data, the first region 201 is displayed the black color, and the second region 202 is displayed the red color according to the red color displaying data refreshed during the second period S212. Thus, the red color displaying data of the three regions 201˜203 of the LCD panel is refreshed and displayed during the first to the third periods S211˜S213.

During the fourth period S214, the first region 201 is refreshed and displayed according to the green color displaying data, the second region 202 neighbored to the first region 201 is displayed the black color, and the third region 203 is displayed the red color according to the red color displaying data refreshed during the third period S213.

During the fifth period S215, the second region 202 is refreshed and displayed according to the green color displaying data, the third region 203 neighbored to the second region 202 is displayed the black color, and the first region 201 is displayed the green color according to the green color displaying data refreshed during the fourth period S214.

During the sixth period S216, the third region 203 is refreshed and displayed according to the green color displaying data, the first region 201 is displayed the black color, and the second region 202 is displayed the green color according to the green color displaying data refreshed during the fifth period S215. Then, the green color displaying data of the three regions 201˜203 of the LCD panel is refreshed during the fourth to the sixth periods S214˜S216.

During the seventh period S217, the first region 201 is refreshed and displayed according to the blue color displaying data, the second region 202 neighbored to the first region 201 is displayed the black color, and the third region 203 is displayed the green color according the green color displaying data refreshed during the sixth period S216.

During the eighth period S218, the second region 202 is refreshed and displayed according to the blue color displaying data, the third region 203 neighbored to the second region 202 is displayed the black color, and the first region 201 is displayed the blue color according to the blue color displaying data refreshed during the seventh period S217.

During the ninth period S219, the third region 203 is refreshed and displayed according to the blue color displaying data, the first region 201 is displayed the black color, and the second region 202 is displayed the blue color according to the blue color displaying data refreshed during the eighth period S218. Finally, the blue color displaying data of the three regions 201˜203 of the LCD panel is refreshed during the seventh to the ninth periods S217˜S219.

In the above embodiment, when the neighboring regions show different colors displaying data, it will make the specific region neighbored to the region which is refreshing a display data display the black color. The display data of each of the regions are have a regulation pattern, for example, the first region 201 displays red→red→black→green→green→black→blue→blue→black and it will start all over again. The displaying data will repeat the color circle itself and thus the above-mentioned embodiment with the regularity is easily implemented by the software, the hardware or the hardware-software co-design.

In order to describe the steps of the present invention clearly, the FIG. 2B is a timing diagram showing a displaying process of the three regions 201˜203 of the LCD panel. The V_{sync} is a vertical synchronization signal to drive the LCD panel. The RS₁ represents the red displaying data for the first region 201. The GS₁ represents the green displaying data for the first region 201. The BS₁represents the blue displaying data for the first region 201. And RB₁, GB₁ and BB₁ respectively represent the signals to lighten up the red, green and blue backlights of the first region 201. The IB₁ represents the signal of displaying the black color of the first region 201.

RS₂, GS₂ and BS₂ respectively represent the signals of transmitting the red, green and blue color displaying data of the second region 202 and RB₂, GB₂ and BB₂ respectively represent the signals to lighten up the red, green and blue backlights of the second region 202. IB₂ is the signal of displaying the black color of the second region 202.

RS₃, GS₃ and BS₃ respectively represent the signals of transmitting the red, green and blue color displaying data of the third region 203 and RB₃, GB₃ and BB₃ respectively represent the signals to lighten up the red, green and blue backlights of the third region 203. IB₃ is the signal of displaying the black color of the third region 203.

During the period S211, the signal RS₁ is enabled for providing the red color displaying data to the first region 201, then the signal RB₁ is enabled to lighten up the red backlight of the first region 201. At the same period S211, the signal IB₂ is enabled to make that the second region 202 displays the black color, and the third region 203 displays the blue color according to the blue color displaying data provided at a previous frame period. Thus, the color deviation problem caused by the red color backlight of the first region 201 and the blue backlight of the second region 202 is avoided.

During the period S212, the signal RS₂ is enabled for providing the red color displaying data to the second region 202, then the signal RB₂ is enabled to lighten up the red backlight of the second region 202. At the same period S212, the signal IB₃ is enabled to make that the third region 203 displays the black color, and the red color backlight of the first region 201 is still illuminated. Thus, the color deviation problem caused by the red color backlight of the second region 202 and the blue color backlight of the third region 203 is avoided.

During the period S213, The signal RS₃ is enabled for providing the red color displaying data to the third region 203 then the signal RB₃ is enabled to lighten up the red backlight of the third region 203. At the same period S213, the signal IB₁ is enable to make that the first region 201 displays the black color, and the red color backlight of the first region 201 is still illuminated.

Accordingly, the green color displaying data transmission, lightening the green color backlight of each region, and displaying the black color in the specific region based on above are accomplished during the periods of S214 to S216. Then, the blue color displaying data transmission and the lightening of the blue color backlight of each region, and displaying the black color in the specific region based on above are accomplished during the periods of S217 to S219.

As shown in the FIG. 2B, it is assumed that the specified resolution of the LCD panel is 1366*768 in the present embodiment, and if the LCD panel is divided into three regions, the specified resolution of each region is 1366*256, which is assumed that the three regions are equally allocated here in order to analyze the timing diagram. If the time for each color of each region to transmit the displaying data to the LCD panel is T, the time of each color backlight of each region to be lightened up is L, and the time to display the black color to the specific region is X.

According to the above mentioned assumption, the time for transmitting one color displaying data to all regions of the LCD panel according to the conventional technique is 3T. Then the time for lightening one color backlight is L. Therefore, it takes the time of 9T+3L to complete the process of displaying one frame by performing the standard color sequence method in the color order of red, green and blue to display data and lighten up the backlight sequentially. If the displaying of dynamic images is at 60 frames per second, and 9T plus 3L will be 16.67 microseconds. The optically compensated birefringence (OCB) LCD panel utilizing the modern technique of bilateral driving mode, wherein the time of transmitting data T to the OCB LCD is about 1.18 microseconds; the time of lightening up the backlight L is quite short at around 2 microseconds, so the brightness of the LCD panel is darker.

In the embodiment, it takes the time of T at most to transmit the displaying data of specified resolution 1366*256 each time and then lightens up the backlight of the corresponding region, wherein the LCD panel is divided into three regions. If the display of dynamic images is required 60 frames per second, then 3T plus 3L plus 3X will be 16.67 microseconds. Further, supposed the IC for inserting black frame is utilized, wherein the time X of displaying the black color is very short at around 0.01 microseconds and supposed the above mentioned OCB LCD panel is used, then the time T for transmitting data is 1.18 microseconds. So the time L for lightening the backlight is about 4.36 microseconds. According to the result of the embodiment, the embodiment of the invention can sufficiently utilize the energy generated by the backlight source, so that the embodiment of the invention can increase the brightness of the LCD panel.

Except the above mentioned embodiment utilizing the IC with the function of inserting black to display the black color at the specific region; if the display panel is the normally white LCD panel, the pixels in the specific region can be inserted a black frame data voltage to accomplish the function of inserting black too. If the display panel is the normally black LCD panel, the pixel discharge function of the scan driver performed the scan function of the specific region could be enabled to display the black color at the specific region, wherein the pixel discharge function, for example, is all high function which make the scan lines in the specific region are at the logic high voltage.

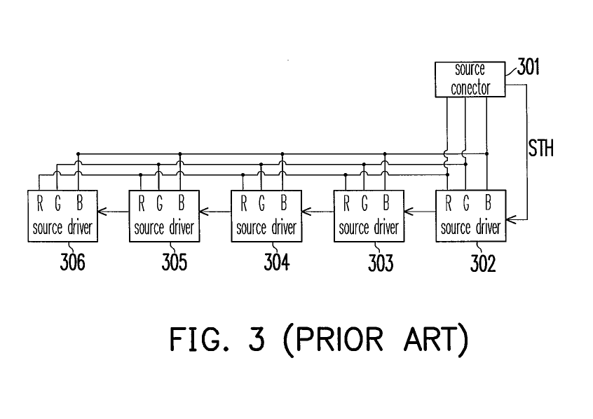

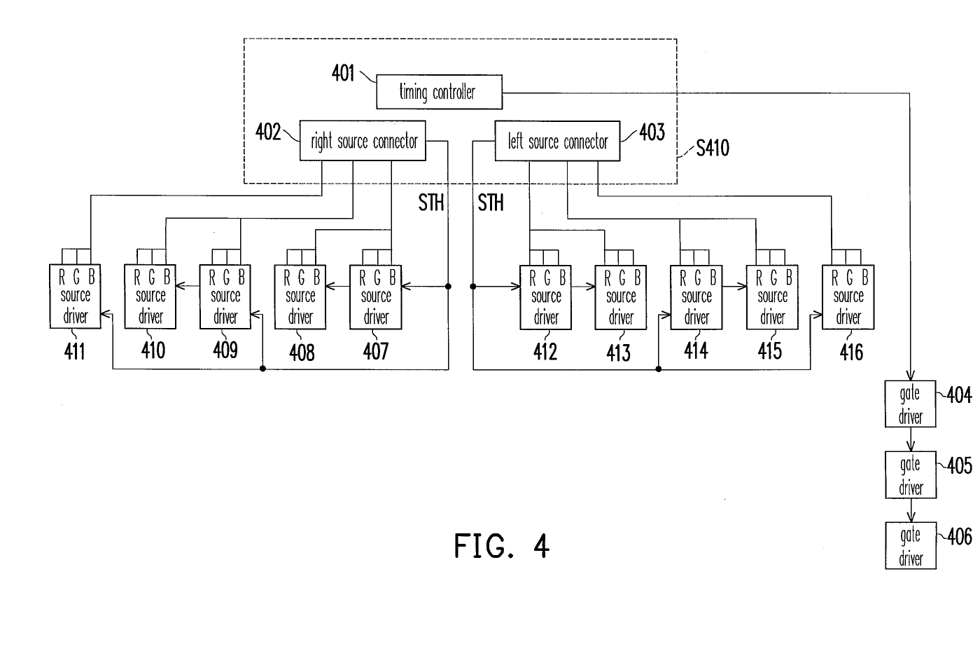

In addition, compared to the conventional design of the LCD panel as shown in the FIG. 3; in the present embodiment, the controlling circuit has made some modifications as shown in FIG. 4. Referring to FIG. 4, a timing controller (T-CON) of the LCD panel S410 controls the gate drivers 404 to 406 sequentially. The gate drivers 404 to 406 respectively control the three regions of the panel 201 to 203. The source drivers 407-411 transmit data sequentially by a right source connector 402 using the method of shift ready according to a synchronization signal (STH). The source drivers 412-416 transmit data sequentially by a left source connector 403 using the method of shift ready according to a synchronization signal (STH). The source drivers could be divided into groups, for example, the source drivers 407 and 408 belong to the same group, so that the data transmission is completed within two STH periods at the most in order to shorten the scanning time, prolong the time for turning on the backlight to be illuminated.

It should be noted that though a possible configuration utilizing the method of scanning backlight to lighten up backlight by region according to the color sequence method in the above mentioned embodiment of the present invention. However, people who are skilled in the art should know that all manufacturers have different designs to the color sequence method, thus the applications of the present invention should not be limited to this possible configuration. In other words, as long as the color deviation problem caused by the neighbored and different backlights is solved by utilizing the method of displaying the black color at a specific region when a region and the neighbored specific region of the display device are used for displayed the different colors, so that the method is conformed to the essence of the present invention.

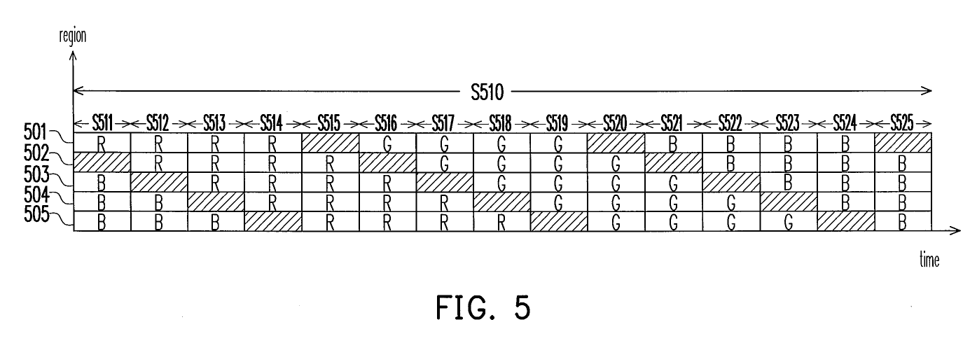

Next, another embodiment is provided for those skilled in the art to easily implement the present invention. Please referring to FIG. 5, FIG. 5 is a schematic diagram showing a displaying process of the LCD panel divided into five regions according to another preferred embodiment. Referring to FIG. 5, the regions 501 to 505 are neighboring to each other. In addition, there are fifteen periods, S511 to S525 within a synchronous time period S510 which is used for displaying a complete frame. One of the five regions 501˜505 of the LCD panel is refreshed by one kind of color displaying data during each period S511˜S525, and the specific region neighbored to the above-mentioned region displays the black color to avoid the color deviation problem.

Suppose that the three colors displaying data of red, green and blue are sequentially refreshed the LCD panel, according to the standard color sequence method. During the first period S511, the first region 501 is refreshed according to the red color displaying data, and then turning on the red color backlight in the region 501. during the same period S511, the second region 502 is displayed the black color and the third to fifth regions 503˜505 are displayed the blue color according to the blue color displaying data refreshed during the previous frame before the period S511. Therefore, the color deviation problem caused by the red color backlight of the first region 501 and the blue color backlight of a previous frame is avoided.

During the period S512, the second region 502 is refreshed according to the red color displaying data, and then the red color backlight of the second region 502 is lightened. During the same period S512, the third region 503 is displayed the black color, and the fourth and fifth regions 504 and 505, is displayed the blue color according to the blue color displaying data refreshed from a previous frame period before the period S512. Thus, the color deviation problem caused by the red color backlight of the second region 502 and the blue color backlight of the third region 503 is avoided.

During the period S513, the third region 503 is refreshed and displayed according to the red color displaying data, and the red color backlight of the third region 503 is lightened. During the same period S513, the fourth region 504 is displayed the black color, and the fifth region 505 is displayed the blue color according the blue color displaying data refreshed from a previous frame period before the period S513. Therefore, the color deviation problem caused by the red color backlight of the third region 503 and the blue color backlight of the region 504 is avoided.

During the period S514, the fourth region 504 is refreshed and displayed according to the red color displaying data, and then the red color backlight of the fourth region 504 is lightened. During the same period S514, the fifth region 505 is displayed the black color. And the color deviation problem caused by the red color backlight of the fourth region 504 and the blue color backlight of the fifth region 505 is avoided.

During the period S515, the fifth region 505 is refreshed and displayed according to the red color displaying data, and then the red color backlight of the fifth region 505 is lightened. During the same period, the first region 501 is displayed the black color.

Similarly, to complete the transmission of the green color displaying data and lightening of green color backlight of the regions sequentially during the sixth to tenth periods, S516 to S520, and accomplish the transmission of the blue color displaying data and lightening of blue color backlight of the regions sequentially during the eleventh to fifteenth periods, S521 to S525.

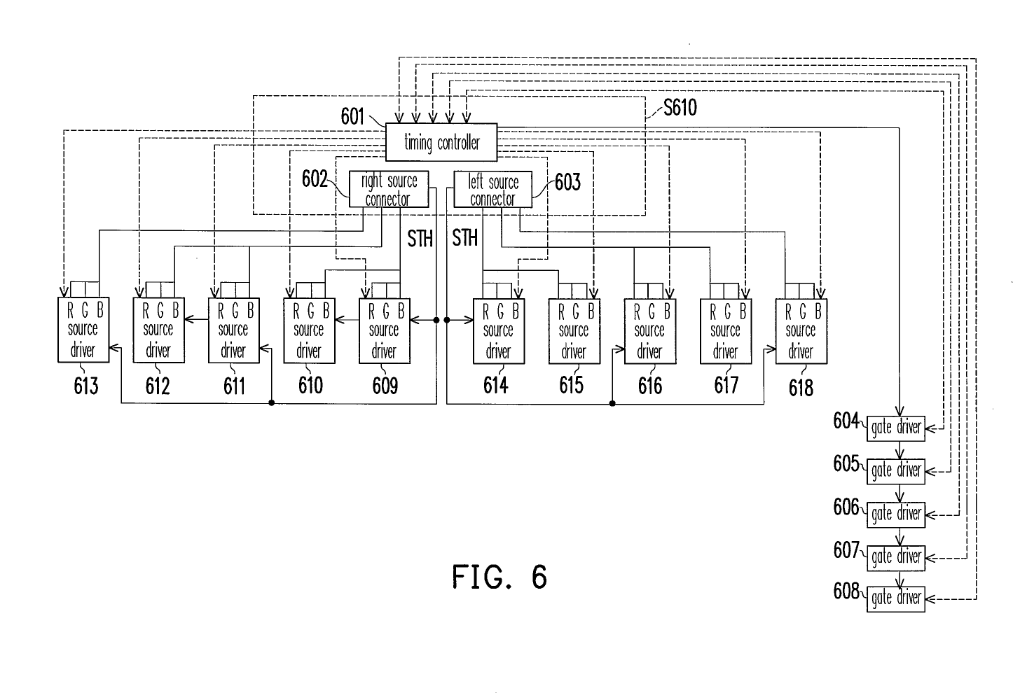

In addition, the driving circuit design of the LCD panel may be modified as shown in the FIG. 6. The timing controller (T-CON) of the LCD panel S610 controls the gate drivers 604 to 608, and the gate drivers 604 to 608 respectively controls the corresponding regions of 501 to 505 of the LCD panel S610. The source drivers 609-613 transmit data sequentially by a right source connector 602 using the method of shift ready according to a synchronization signal (STH) and the source drivers 614-618 transmit data sequentially by a left source connector 603 using the same method. The source drivers could be divided into groups, for example, the source drivers 609 and 610 belong to the same group in order to shorten the scanning time to prolong the time for the backlight source to be illuminated.

In the design of the control circuit of the displaying panel, each of the source drivers 609 to 618 may further add a pin to make all source pins connected to the data lines of the LCD output the black frame data voltage simultaneously to block the backlight of a scan line enabled by gate driver, so that the scan line will be display the black color, and thus the source driver is un-required to receive the black color displaying data in sequence according to the synchronization signals (STH). Each of the gate drivers 604 to 608 respectively controlled each of the regions of the LCD may further add a pin for controlling all of the gate pins connected to the scan lines in each region, wherein the gate drivers control the regions of the panel and the gate pins of the drivers in accordance with the all-gate-on signals, to accomplish the objective of displaying the black color and blocking the backlight of the specific region.

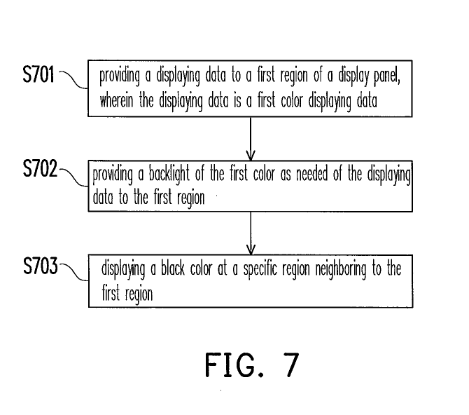

According to the embodiments described above, the steps of the following method could be generalized. FIG. 7 schematically shows a flow chart illustrating a method for updating displaying data according to an embodiment of the present invention. Please refer to FIG. 7, first, in step S701, providing a displaying data to a first region of a display panel, wherein the displaying data is a first color displaying data. For example, in the embodiment of the above-mentioned FIG. 2A, a red color displaying data is provided to the first region 201 of the LCD panel during the S211 period.

The following step S702, providing a backlight of the first color as needed of the displaying data to the first region, for example, in the embodiment of the above-mentioned FIG. 2A, a red color backlight source is illuminated in the first region 201.

Final step S703, displaying a black color at a specific region neighboring to the first region, for example, in the embodiment of the above-mentioned FIG. 2A, wherein the second region 202 neighbored to the first region 201 displays the black color, wherein the first region displays the red color according to the red color displaying.

In summary, the present invention provides a method to make the specific region neighbored to the region display the black color wherein the displaying color of the region and the displaying color of the specific region are represented the different colors during the same period, which utilizing the method of scan backlight to lighten up backlight by region in order to avoid the color deviation problem among different light sources, prolong the time for the backlight and fully utilize the energy created by the backlight source. Moreover, the present invention further achieves the objective of displaying color within limited reacting time of the LCD panel by correcting the design of the LCD panel.

Although the present invention has been disclosed above by the preferred embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A method for driving a display device, driving a display panel, the method comprising:
providing a first displaying data to a first region of the display panel, wherein the first displaying data is the data of a first color;
providing a backlight of the first color at the first region; and,
displaying a black color at a specific region neighboring to the first region.

2. The method for driving a display device as claimed in claim 1, wherein the displaying panel is a normally black LCD panel and the step of displaying the black color at the specific region comprising:
enabling a pixel discharge function of a scan driver, wherein the scan driver is utilized for performing the scan function in the specific region.

3. The method for driving a display device as claimed in claim 2, wherein the pixel discharge function is all high function, to control a plurality of scan lines of the specific region to receive the logic high voltage.

4. The method for driving a display device as claimed in claim 1, wherein the display panel is a normally white LCD panel and the step of displaying the black color at the specific region comprising:
inputting a black frame data voltage to the pixels in a scan line when a scan driver of the LCD panel is driven the scan line of the specific region.

5. The method for driving a display device as claimed in claim 1, wherein the method of the specific region for displaying black color comprises:
turning off the backlight of the specific region, when the color display in the specific region is different from the first color.

6. The method for driving a display device as claimed in claim 1, wherein the specific region comprises a plurality of neighboring specific scan lines of the display panel, and the first region comprising a plurality of neighboring first scan lines of the display panel.

7. The method for driving a display device as claimed in claim 1, wherein the display panel further comprising a second region and a third region, wherein the first region is neighboring to the second region, wherein the second region is neighboring to the third region.

8. The method for driving a display device as claimed in claim 7, further comprising the following steps:
displaying a first color at a first region, the black color at the second region, and a second color at third region during a first period of a displaying synchronous time period;
displaying the first color at the first and second regions and displaying the black color at third region during a second period of the displaying synchronous time period; and
displaying the first color at the second and third regions and displaying the black color at the first region during a third period of the displaying synchronous time period.

9. The method for driving a display device as claimed in claim 8, wherein the synchronous time period comprising 1^{st}˜9^{th} periods;
displaying the first color at the first region, the black color at the second region, and the second color at the third region during the 1^{st} period;
displaying the first color at the first and second regions and displaying the black color at the third region during the 2^{nd} period;
displaying the first color at the second and third regions and displaying the black color at the first region during the 3^{rd} period;
displaying a third color at the first region, the black color at the second region, and the first color at the third region during a 4^{th} period;
displaying the third color at the first and second regions and displaying the black color at third region during the 5^{th} period;
displaying the third color at the second and third regions and display the black color at the first region during the 6^{th} period;
displaying the second color at the first region, the black color at the second region, and the third color at the third region during the 7^{th} period;
displaying the second color at the first and second regions and displaying the black color at the third region during the 8^{th} period; and,
displaying the second color at the second and third regions and displaying the black color at the first region during the 9^{th} period.

10. The method for driving a display device as claimed in claim 8, wherein the first, the second and the third colors are red, green and blue, respectively.

11. The method for driving a display device as claimed in claim 1, wherein the display panel is an optically compensated birefringence type LCD panel.
